(19) United States
(12) Patent Application Publication
(10) Pub. No.: US 2026/0113670 A1
(43) Pub. Date: Apr. 23, 2026

(54) SYSTEM AND METHOD FOR ALLOCATING RESOURCES IN A COMMUNICATION NETWORK

(71) Applicant: Quanta Cloud Technology Inc., Taipei City (TW)

(72) Inventors: Liang-Cheng LIAO, Taipei City (TW); Hsiao-Cheng HSU, Taipei City (TW); Ji-Jeng LIN, Taipei City (TW); Chia-Jui LEE, Taipei City (TW)

(21) Appl. No.: 18/924,543

(22) Filed: Oct. 23, 2024

(51) Int. Cl. H04W 36/00

(52) U.S. Cl. CPC H04W 36/0058; H04W 36/0072

(57) ABSTRACT

A system includes one or more data processors. The system further includes a non-transitory computer-readable storage medium containing instructions which, when executed on the one or more data processors, cause the one or more data processors to perform operations. The operations include receiving a measurement report from a user equipment, updating measurement configuration based on the measurement report, forwarding a measurement result including status of signal strengths of a serving cell and a neighboring cell to a RAN intelligent controller, and updating (i) an SRE table based on an ANR, (ii) an ASRE table, or (iii) both, based on the measurement result. The SRE table stores cell-based information, and the ASRE table stores user equipment based information.

### FIELD OF THE INVENTION

The present invention relates generally to communications technology in computing systems, and more specifically, to systems and methods for allocating periodic resources to one or more user equipment.

### BACKGROUND OF THE INVENTION

Computing systems (e.g., servers, desktop computers, laptop computers, smartphones, etc.) are used in different contexts for a wide range of functions. Computing systems can sometimes communicate over wired or wireless technology. Computing systems, such as user equipment, communicate with other communication devices using wireless communication networks. Examples of such wireless communication networks include cellular networks like 4G LTE and 5G, Wi-Fi networks, Bluetooth networks, etc. Computing systems that communicate over wireless networks typically undergo some network discovery to determine how to appropriately send information over the network. In some wireless networks, network resources are allocated and communicated to the computing systems so that these computing systems have the appropriate information for better information coordination within the network. The present disclosure provides systems and methods associated with allocating network resources to one or more computing system.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a system includes one or more data processors. The system further includes a non-transitory computer-readable storage medium containing instructions which, when executed on the one or more data processors, cause the one or more data processors to perform operations. The operations include receiving a measurement report from a user equipment, updating measurement configuration based on the measurement report, forwarding a measurement result including status of signal strengths of a serving cell and a neighboring cell to a radio access network (RAN) intelligent controller, and updating (i) an SRS relation enabler (SRE) table based on an automatic neighbor relationship (ANR), (ii) an Automatic SRS relation enabler (ASRE) table, or (iii) both, based on the measurement result. The SRE table stores cell-based information, and the ASRE table stores user equipment based information.

In an implementation, the SRE table is updated to change a status of an SRS resource allocation of the user equipment in cell coverage. In an implementation, the ASRE table is updated to change a status of an SRS resource allocation of the user equipment. In an implementation, the operations further include receiving a notification from the user equipment that a first radio resource control (RRC) reconfiguration is completed, receiving, from the user equipment, signal strengths of the neighboring cell and the serving cell relative to the user equipment, and providing a second RRC reconfiguration to the user equipment. The second RRC reconfiguration includes a handover request with the neighboring cell being a target cell. The second RRC reconfiguration can further include an SRS configuration.

In an implementation, the SRE table is an extension of a neighbor relation table as defined in the 3GPP. In an implementation, the SRE table is updated by a near real time radio access network intelligent controller (nRT-RIC). In an implementation, the SRE table is updated by an open-central unit (O-CU) stack in a base station. In an implementation, the ASRE table is updated to track candidate user equipment. The candidate user equipment is one or more user equipment that can execute a handover from the serving cell to the neighboring cell. A candidate row of the ASRE table can identify a first cell, a second cell, a first user equipment, and an SRS allocation of the first user equipment being enabled. In an implementation, the ASRE table is updated to track dropped user equipment, the dropped user equipment being one or more user equipment where an SRS allocation is disabled. A dropped row of the ASRE table can identify at least one cell and one user equipment.

According to certain aspects of the present disclosure, a method performed by a computing system includes receiving a measurement report from a user equipment, updating measurement configuration based on the measurement report, forwarding a measurement result including status of signal strengths of a serving cell and a neighboring cell to a RAN intelligent controller, and updating (i) an SRE table based on an ANR, (ii) an ASRE table, or (iii) both, based on the measurement result. The SRE table is configured to store cell-based information, and the ASRE table is configured to store user equipment based information.

In an implementation, the SRE table is updated to change a status of an SRS resource allocation of the user equipment in cell coverage. In an implementation, the ASRE table is updated to change a status of an SRS resource allocation of the user equipment. In an implementation, the method further includes receiving a notification from the user equipment that a first RRC reconfiguration is completed, receiving, from the user equipment, signal strengths of the neighboring cell and the serving cell relative to the user equipment, and providing a second RRC reconfiguration to the user equipment. The second RRC reconfiguration includes a handover request with the neighboring cell being a target cell. The second RRC reconfiguration can further include an SRS configuration. In an implementation, the SRE table is an extension of a neighbor relation table as defined in the 3GPP. In an implementation, the ASRE table is updated to track candidate user equipment. The candidate user equipment is one or more user equipment that can execute a handover from the serving cell to the neighboring cell. In an implementation, the ASRE table is updated to track dropped user equipment. The dropped user equipment is one or more user equipment where an SRS allocation is disabled.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a wireless system architecture, according to certain aspects of the present disclosure.

FIG. 2 is a block diagram of a gNodeB (gNB) cell interfacing with a user equipment, according to certain aspects of the present disclosure.

FIG. 3 provides functions of an nRT-RIC, according to certain aspects of the present disclosure.

FIG. 4 is an architecture showing an example SRE table being updated, according to certain aspects of the present disclosure.

FIG. 5 is an example ASRE table, according to certain aspects of the present disclosure.

FIG. 6 is an example scenario, according to certain aspects of the present disclosure.

FIG. 7 is a first example scenario for changing sounding reference signal (SRS) resource allocation, according to certain aspects of the present disclosure.

FIG. 8 is a second example scenario for changing SRS resource allocation, according to certain aspects of the present disclosure.

FIG. 9 is a third example scenario for changing SRS resource allocation, according to certain aspects of the present disclosure.

### DETAILED DESCRIPTION

In 3^{rd} Generation Partnership Project (3GPP), a layer 3 messages are part of the protocol stack's control plane. The control plane is responsible for establishing, maintaining, and releasing connections between user equipment (UE) and the radio network (e.g., evolved NodeB in LTE network, next generation NodeB in 5G, etc.). Layer 3 messages in the radio resource control (RRC) layer can be used to allocate and reallocate resources to UEs. Layer-3 message RRC reconfiguration can be used to set up or modify RRC configurations so that the resources can be reallocated to UEs. The following RRC components/features can be configured: (1) Radio Bearer, (2) Measurement, and (3) secondary cells (SCells) or Cell Group configurations. When a UE completes a protocol data unit (PDU) session setup process or SCells is added/modified in a carrier aggregation (CA) process, the always-on or always-off SRS periodic resources allocation is triggered by each cell initials up. However, when the UE changes location from a first cell to a second cell, the cell cannot dynamically change the sounding reference signal (SRS) resource allocation in real time. In 3GPP, there are three types of SRS resource allocation: (1) aperiodic resource allocation, (2) semi-persistent resource allocation, and (3) periodic resource allocation. Embodiments of the present disclosure provide systems and methods that improve periodic resources allocated to multiple UEs by adopting 3GPP 5G SRS Codebook mode.

For example, 3GPP automatic neighbor relationship (ANR) of the radio access network (RAN) is used to manage a neighbor relation table. The ANR can reside in the next generation Node B (gNodeB) and facilitate finding and adding new neighbors to the neighbor relation table. The neighbor removal function can remove outdated neighbor relations and update neighbors' relations. Embodiments of the present disclosure optimize network function based on two tables to enable dynamic SRS resource allocation among cells so as to provide uninterrupted telecommunication services. The first table is a SRS relation enabler (SRE) table that tracks cell-based SRS resource enablement/disablement features, and the second table is an automatic SRS relation enabler (ASRE) table that tracks UE-based SRS resource enablement/disablement features. These two tables can be updated when the RRC reconfiguration process is triggered.

RRC reconfiguration process can be triggered, for example, during a handover process. Handover is an example that occurs when a UE moving from a first cell to a second cell. Typically, in handover, the primary cell decides to add/modify SCells to the UE, and the cell adds/updates the measurement configuration to the UE. Embodiments of the present disclosure use the SRE table and the ASRE table to dynamically enable or disable SRS resource allocation in the gNodeB. SRS resource allocation can be managed at the operations and maintenance (OAM) in service management and orchestration (SMO), near-real time RAN intelligent controller (nRT-RIC), or open-central unit (O-CU) stack in gNodeB.

RAN managers can dynamically allocate the SRS resource for each cell based on the network resource management and allocate the SRS resource for the specific UEs. In an example, embodiments of the present disclosure enable tracking UE location (positioning) in a specified location or allocating the SRS resource for the high-priority UEs. In another example, embodiments of the present disclosure enable allow for network resource management where the gNodeB can decide to disable SRS resource per UE when the uplink resource reaches the value of overloading.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

In a mobile or cellular/wireless network, two domains are typically provided. The first domain is a radio access network (RAN) and the second domain is a core network. The radio access network is typically the final link between the core network and users' wireless devices (e.g., phones, user equipment, etc.). The radio access network includes antenna(s) and base station(s), and signals from users' wireless devices are digitized in the RAN base station and connected to the core network. The core network can provide access controls, ensuring users are authenticated for services they are using. The core network can route telephone calls over the public switched telephone network. The core network can allow operators to charge for calls and data use. The core network can connect users to the rest of the world via the Internet. The core network can facilitate handovers as users move from coverage provided by one RAN tower to another RAN tower. How these two domains (i.e., the RAN and the core network) are organized can differ in wireless network implementations.

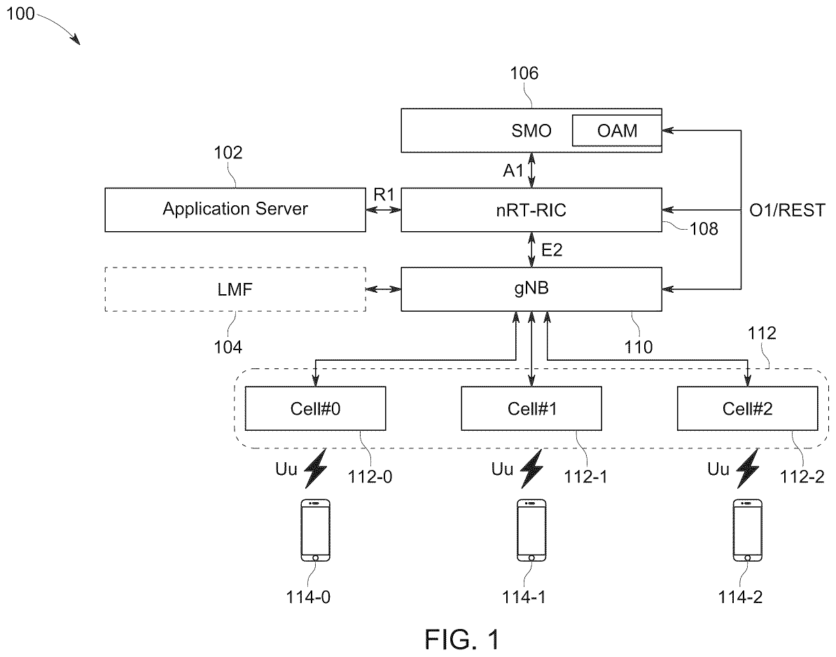

Referring to FIG. 1, a wireless system architecture 100 is provided, according to certain aspects of the present disclosure. In some implementations, the wireless system architecture 100 implements a 5G architecture according to 3GPP. In some implementations, the wireless system architecture 100 implements the open RAN (ORAN) architecture. The wireless system architecture 100 includes an application server 102, a location management function (LMF) 104, a service management and orchestration (SMO) engine 106, a near-real time RAN intelligent controller (nRT-RIC) 108, a gNodeB (gNB) 110 managing multiple cells 112 (e.g., cell #0 112-0, cell #1 112-1, cell #2 112-2, etc.), and UEs 114 (e.g., UE 114-0, UE 114-1, UE 114-2, etc.). Each of the LMF 104, SMO engine 106, nRT-RIC 108, and gNB 110 is a combination of hardware and software configured to perform specific functionality as described in the following paragraphs. In some cases, a RAN intelligent controller is a combination of the nRT-RIC 108 and the SMO engine 106.

The application server 102 can execute rApps. The application server 102 interacts with the nRT-RIC 108 (or in some cases the SMO engine 106) using the RI interface. rApps are software applications that use the capabilities exposed by the nRT-RIC 108 over the RI interface to realize different RAN management and optimization. The RI interface spans multiple application programming interfaces (APIs) that provide capability to rApps for implementing functions associated with the rApps. For example, RI interface can allow access to network configuration, performance and topology data, policy execution, security infrastructure, etc., thus supporting rApp execution. The RI interface allows rApps to access supporting functions provided by the SMO engine 106 and/or the nRT-RIC 108.

The LMF 104 is configured to provide positioning information for UEs. The LMF 104 can receive positioning measurements and information from UEs and/or the gNB 110. UEs (e.g., UE 114-0, UE 114-1, UE 114-2, etc.) can be smartphones, internet of things (IoT) devices like sensors, vehicles, etc., or some other computing device with a wireless connection to at least one cell in the multiple cells 112.

The SMO engine 106 is configured to handle management, orchestration, and automation aspects of various components of the wireless system architecture 100 (e.g., various components of the ORAN architecture). The SMO engine 106 provides and consumes services such as authentication, authorization, service registration and discovery, data management, and trained model sharing using standardized service-based interfaces. The service-based interfaces include, for example, A1, O1, REST, etc. The A1 interface is an interface between the SMO 106 and the nRT-RIC 108 introduced by the ORAN architecture. The A1 interface can support policy-based guidance of the nRT-RIC 108. The O1 interface is provided between the SMO engine 106 and the nRT-RIC 108 and the gNB 110. The O1 interface facilitates a common and open approach to implementing management functionality between a management entity like the SMO engine 106 and various managed elements (e.g., the nRT-RIC 108 and/or the gNB 110). In some implementations, the REST API, interface, or principles can be used by the SMO engine 106 for managing the managed elements. In some implementations, some of the functions of the SMO engine 106 can be represented in operations and maintenance (OAM), for example, the OAM can dynamically enable or disable SRS resource allocation.

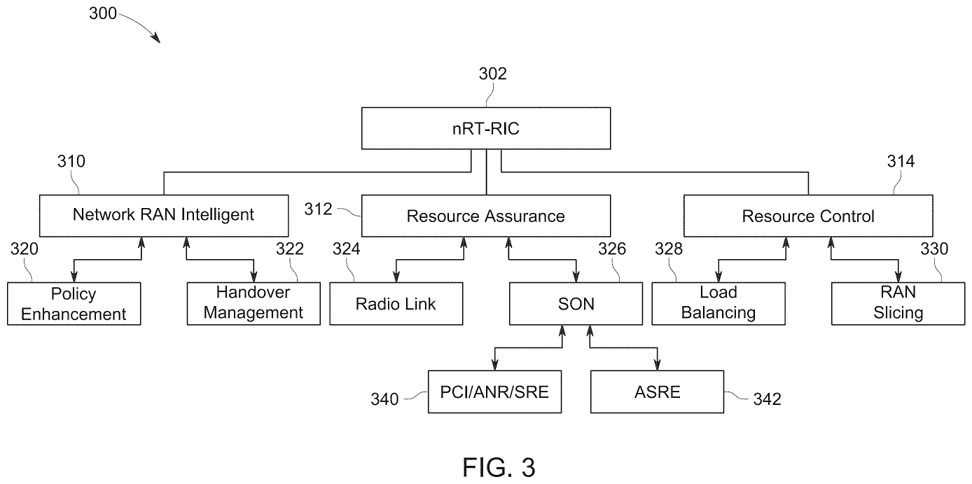

The nRT-RIC 108 is a RIC that deals with functionality and operations at a time scale close to real-time (e.g., about 10 ms to 1 s). The nRT-RIC 108 connects to the gNB 110 via an E2 interface. The nRT-RIC 108 is configured to control RAN elements and optimizes RAN resources. The nRT-RIC 108 can run xApps which may consist of one or more microservices. FIG. 3 provides some functions of an nRT-RIC 302, according to some implementations of the present disclosure. The nRT-RIC 302 is similar to or the same as the nRT-RIC 108. In some implementations, the nRT-RIC 302 provides network RAN intelligence 310, resource assurance 312, and/or resource control 314.

Network RAN intelligence 310 includes policy enhancement 320 and handover management 322. Resource control 314 includes load balancing 328 and RAN slicing 330. Resource assurance 312 includes managing radio link 324 and self-organizing network (SON) 326 functionality. SON 326 functionality relies on several techniques including an ANR and automated configuration of physical cell identity (PCI). Embodiments of the present disclosure expand SON 326 functionality by managing an SRE table. Embodiments of the present disclosure further expand SON 326 by managing an ASRE table. In FIG. 3, PCI/ANR/SRE are grouped together under item 340, and ASRE is provided under item 342.

The SON 326 consists of PCI collisions, PCI confusions, ANR sub-functions, etc., in which ANR sub-function is the main sub-function relied upon in some implementations of the present disclosure. In some implementations, to realize network optimization, the nRT-RIC 302 can control cell-based SRE enablers and UE-based ASRE enablers in SON 326 by respectively adopting a neighbor relation table (NRT), that is the SRE, and the ASRE.

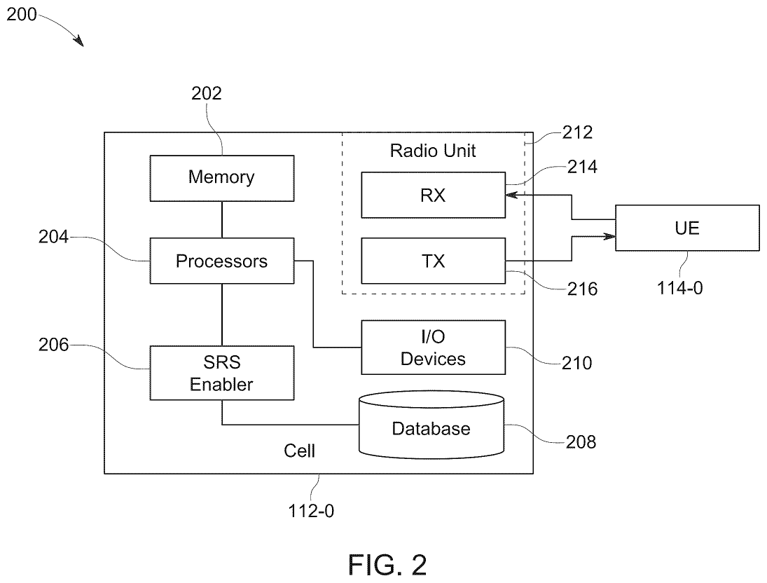

Referring back to FIG. 1, the gNB 110 provides radio access to UEs. The gNB 110 can include multiple cells 112 that provide telco services to the UEs. The Uu interface allow the UEs to connect to the multiple cells 112 of the gNB 110. FIG. 2 is a block diagram 200 of a gNB cell, the cell #0 112-0 cell, interfacing with the UE 114-0, according to certain aspects of the present disclosure. FIG. 2 includes an exemplary network base station in the gNB cell 112-0. The gNB cell cell #0 112-0 includes memory 202 (e.g., random access memory (RAM)), processors 204, SRS enabler 206, database 208, input/output devices 210, and a radio unit 212 (or sometimes referred to as remote radio units). The radio unit 212 includes receivers (RX) 214 and transmitters (TX) 216. The radio unit 212 can be either inside or outside the cell #0 112-0. For example, three radio units can be respectively either inside or outside the cell #0 112-0, the cell #1 112-1, and the cell #2 112-2. Any one cell can only have one radio unit 212. The SRS enabler 206 can be controlled by the SMO 106 (e.g., the OAM function of the SMO 106), the nRT-RIC 108, and/or O-CU. The O-CU is a logical node that implements a set of base station protocols such as radio resource control (RRC), packet data convergence protocol (PDCP), and service data adaptation protocol (SDAP). The SRS enabler 206 can update the ASRE or SRE table in the database 208. Measurement configurations can be sent to the UE 114-0 through the transmitter 216, and the measurement result can be received from the UE 114-0 through the receiver 214.

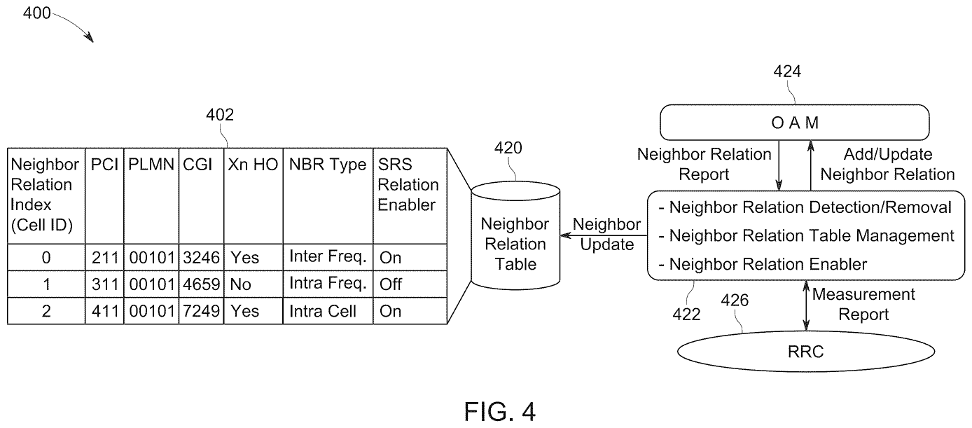

FIG. 4 is an architecture 400 showing an example SRE table 402 being updated, according to certain aspects of the present disclosure. The SRE table 402 is extended from a neighbor relation table (NRT) 420 to include an SRS relation enabler column. A cell-based SRE enabler, is used to control the 3GPP ANR sub-function by updating the SRE table 402. Defined by 3GPP, in the SON function, the sub-function ANR adopts a table with the items “Neighbor Relation Neighbor Index” (namely cell ID), “Physical Cell Identity” (PCI), “Public Land Mobile Network” (PLMN), “Cell Global Identifier” (CGI), and “Xn Handover allowed.” This ANR table can be updated by OAM 424 (e.g., OAM of the SMO engine 106) based on the measurement report(s) sent by the UEs. By adding a new column “SRS Relation Enabler” to the NRT 420, the SRE table 402 can be updated by not only the OAM 424 but also the nRT-RIC 108 and O-CU of the gNB 110. Through a connection to an RRC 426, the gNB 110 knows the number of UEs camp on the multiple cells 112, considers the network resource allocation, and decides that SRS is enabled or disabled based on the measurement report.

In the example of FIG. 4, both Cell ID 0 and Cell ID 2 with SRS enabled are to allocate resources, while Cell ID 1 with SRS disabled is not to allocate resources at the initial cell setup. The SRS resources can be dynamically allocated (with SRS feature enabled) or de-allocated (with SRS feature disabled) based on the demands for individual Cell ID while serving UEs. For example, for Cell ID 0, when SRS resources reach limits or are required to be reserved for another purpose, the SRS feature can be disabled in real time by the OAM 424. The OAM 424 can remove and/or add items to the NRT table 420 while the RRC 426 updates the OAM 424 to enable this function. If FIG. 4, functions 422 include neighbor relation detection/removal, neighbor relation table management, and neighbor relation enabler can trigger neighbor updates of the SRE table 402.

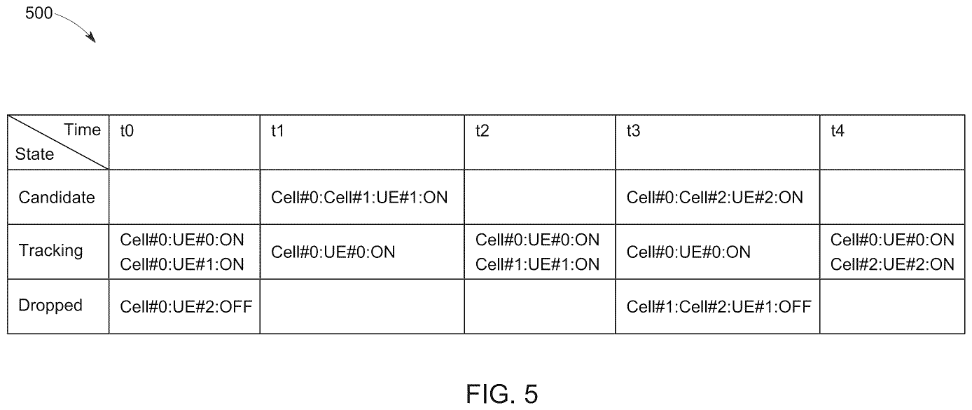

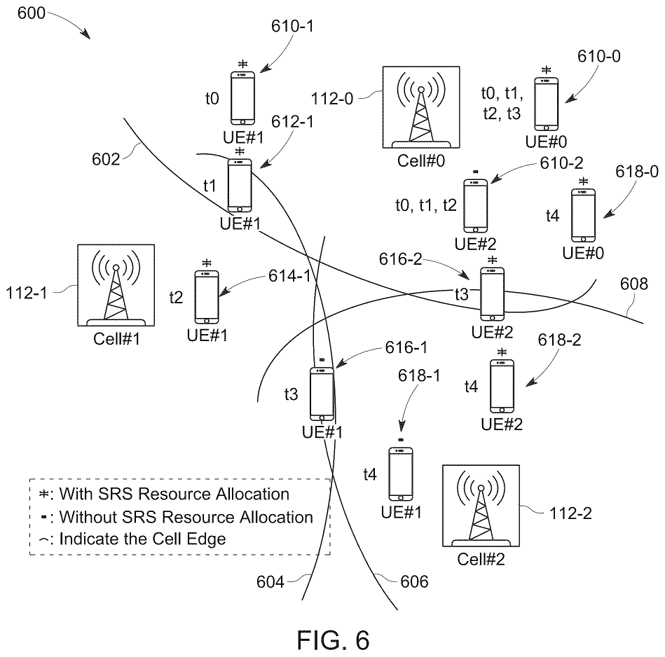

Referring to FIG. 5, an example ASRE table 500 is provided for an example scenario of FIG. 6, according to some implementations of the present disclosure. FIG. 6 provides an example scenario 600 for relative locations of UEs at different timestamps. Referring to FIG. 5, a UE-based ASRE enabler (e.g., the ASRE table 500) includes several timestamps (i.e., t0, t1, t2, t3, and t4) as columns and three example states (i.e., Candidate, Tracking, and Dropped) as rows. The ASRE table 500 can be adopted to automatically and dynamically enable or disable SRS resource allocation by, for example, the OAM 424, RIC (e.g., the nRT-RIC 302), SMO (e.g., the SMO engine 106), etc.

In the ASRE table 500, the Candidate row includes multiple Cell IDs, UE IDs, and enabled SRS, indicating a UE can prepare to execute “handover” to a target cell and enable SRS transmission. For example, at timestamp t1, cell #0 and cell #1 are identified to include UE #1, and SRS of UE #1 is enabled (i.e., status is ON). This corresponds to position 612-1 in FIG. 6. As can be seen, in FIG. 6, at timestamp t1, UE #1 is within cell edge 602 of cell #0 112-0 and cell edge 604 of cell #1 112-1. In another example, at timestamp t3, cell #0 and cell #2 are identified to include UE #2, and SRS of UE #2 is enabled (i.e., status is ON). This corresponds to position 616-2 in FIG. 6. As can be seen, in FIG. 6, at timestamp t3, UE #2 is within cell edge 608 of cell #2 112-2 and the cell edge 602 of cell #0 112-0.

In the ASRE table, the Tracking row includes one or more pairwise matching of Cell IDs and UE IDs with SRS transmission enabled. For example, at timestamp t0, cell #0 and UE #0 are matched with SRS of UE #0 enabled (i.e., status is ON). Also cell #0 and UE #1 are matched with SRS of UE #1 enabled. Referring to FIG. 6, position 610-0 corresponds to the cell #0 and UE #0 matching at timestamp t0 with SRS resource allocation enabled. Similarly, position 610-1 corresponds to the cell #0 and UE #1 matching at timestamp t0 with SRS resource allocation enabled. The rest of the columns for timestamps t1 through t4 can be populated for the Tracking row in a similar manner as described. In some implementations, the Tracking row only includes UEs that are within a single cell's edge. For example, at time t1, UE #0 and UE #1 both have SRS resource allocation enabled, but UE #1 is within the cell edges 604 and 602 of cell #0 112-0 and cell #1 112-1, respectively, and UE #0 is only within the cell edge 602 of cell #0 112-0. So UE #1 appears in the Candidate row while UE #0 appears in the Tracking row.

In the ASRE table 500, in the Dropped row, the UE ID is stopped to transmit SRS during a handover process (e.g., at timestamp t3, UE #1 changes from cell #1 to cell #2). To explain further, at timestamp t0, UE #0 and UE #1 transmit SRS signals at cell #0 (see positions 610-0 and 610-1) and UE #2 drops SRS transmission (see position 610-2). At timestamp t1, UE #1 prepares to execute handover to cell #1, and the SRS transmission is enabled (see position 612-1). At timestamp t2, UE #0 and UE #1 keep transmitting SRS signals (see positions 610-0 and 614-1, respectively). At timestamp t3, UE #1 stops transmitting the SRS signal when the handover process is completed while UE #2 enables SRS transmission when the handover process is completed (UE #2 changes from Cell #0 to Cell #2). See positions 616-1 and 616-2. At timestamp t4, the UE #0 and UE #2 are tracking the SRS transmission (see positions 618-0 and 618-1). Regarding the different UE mobility, the handover process is illustrated in FIG. 6 showing evolution of the different positions of the UEs as captured in the ASRE table 500. Note that in some implementations, at timestamp t3, UE #1 is between cell edge 604 of cell #1 112-1 and cell edge 606 of cell #2 112-2 but the SRS resource allocation is disabled. The Dropped row includes UEs where the SRS resource allocation is disabled (i.e., status is OFF). As provided in FIG. 5, the Dropped row can include a pairwise matching of Cell ID and UE ID, as in timestamp t0, or can include two or more Cell IDs along with a UE ID, as in timestamp t3. The Dropped row shows which UEs do not need to transmit an SRS.

In some implementations, the Dropped row only includes Dropped UE information only once to conserve resources such that Dropped UE information is maintained at a timestamp when dropped. For example, at timestamp t0, an indication of the UE #2 being dropped is recorded, but this information is not carried through in timestamp t1 or timestamp t2. Similarly, at timestamp t3, an indication of UE #1 being dropped is recorded, but this information is not carried through in timestamp t4. The SRS resource allocation is used for 5G positioning such that the OFF state or Dropped state tracking of many UEs is not important for this application. In some implementations, the Dropped row can be maintained for multiple timestamps in a database for other purposes.

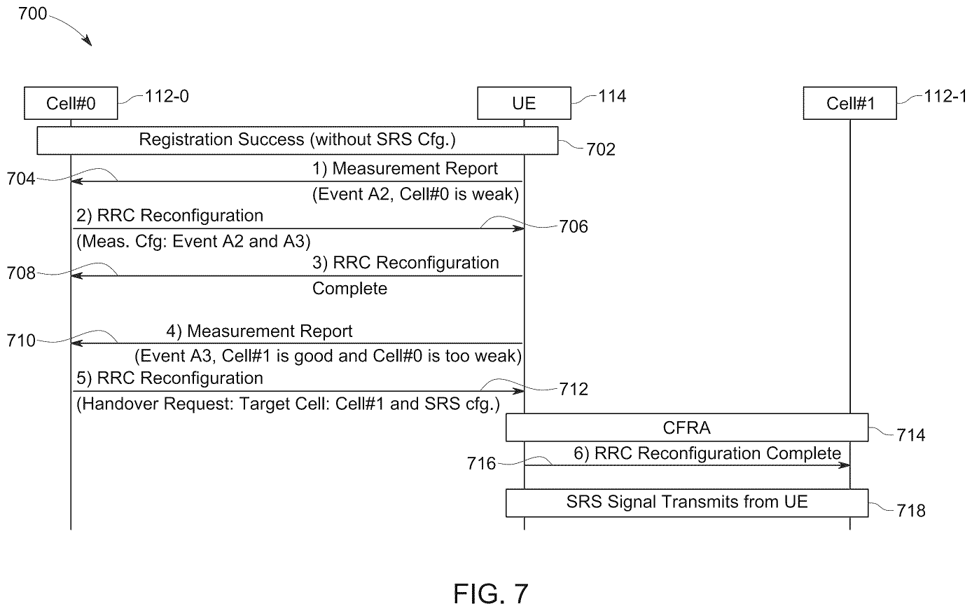

FIG. 7 is a first example scenario 700 for changing SRS resource allocation, according to certain aspects of the present disclosure. In the scenario 700, the SRS resource allocation is changed from an OFF status to an ON status. The scenario 700 includes the cell #0 112-0, a UE 114, and the cell #1 112-1. At step 702, the UE 114 successfully registers. In some implementations, the UE 114 registers with or without SRS configuration. In some implementations, the UE 114 registers to the network and adopts the measurement configuration for Event A2 defined in 3GPP. When the serving cell (i.e., cell #0) is weak, Event A2 is the criteria to be triggered to send the management report. In some implementations, the management report may include signal intensity in relation to the distance between UE 114 and the cell #0 112-0.

At step 704, when the signal in cell #0 112-0 is weak, the Event A2 criteria defined in 3GPP will be triggered. Currently, SRS transmission is disabled. When the UE 114 is separated from the cell #0 112-0 by a certain distance, the UE 114 will send the measurement report to the cell #0 112-0 regarding the status of the weak serving cell (i.e., the cell #0 112-0). In some implementations, the distance that triggers sending the measurement report is based on the environment, frequency, path loss of obstacles, and antenna gain. One or more free-space path loss formulas can be used to determine the distance, for example, the Friis free space propagation model.

At step 706, the cell #0 112-0 will update the measurement configuration with Event A3 defined in 3GPP. Then, the cell #0 112-0 will forward the measurement result. In some implementations, the measurement result forwarded indicates that the signal of a neighboring cell (e.g., the cell #1 112-1) has become good, and the signal of the serving cell (e.g., the cell #0 112-0) is too weak. The measurement result is forwarded to the OAM 424 (and/or xApps running in the nRT-RIC 302 and/or the ANR) to update the SRE table and/or the ASRE table. Updating the SRE table and/or the ASRE table allows enabling SRS transmission of the UE 114 before the handover process from the cell #0 112-0 to the cell #1 112-1 is triggered. RRC reconfiguration is sent from the cell #0 to the UE 114.

In some implementations, SRE table management feature can be enabled or disabled. SRE table management feature and ASRE table management feature can both be enabled and disabled at the same time. That is, when SRE feature is disabled, ASRE feature is disabled, and when SRE feature is enabled, ASRE feature is enabled. The SRE table can be used without the ASRE table, but the ASRE table cannot be used without first enabling the SRE table.

In some implementations, “good” is in accordance with criteria Event A3, and “weak” is in accordance with criteria Event A2 as defined in 3GPP. In some cases, Event A2 has an Event A2 threshold of about −90 dBm. In some cases, the Event A2 threshold is a value between approximately −90 dBm and −100 dBm. In some cases, Event A2 has a hysteresis of −5 dBm such that Event A2 is triggered when serving cell signal strength plus hysteresis is less than the threshold. In some cases, Event A3 is triggered when offset between a serving cell's signal strength and a neighboring cell's signal strength is greater than an Event A3 threshold, such that neighboring cell's signal is at least an Event A3 threshold greater than serving cell's signal strength. In some cases, Event A3 threshold can be 5 dBm, 10 dBm, etc.

In some implementations, “good” and “weak” are defined according to the following table from the ORAN Test and Integration Focus Group End-to-End Test Specification (Table 1). In Table 1, “weak” can be analogous to “poor” or “fair.” Many different factors affect signal strength and can include proximity to cellular tower, load in neighbor cells, surrounding physical barriers, and/or weather conditions.

TABLE 1
Reference Signal Received Power (RSRP) and Signal to Noise and Interference
Ratio (SINR) thresholds for various radio conditions

| Radio | RSRP (dBm) | DL SINR (dB) | |
|---|---|---|---|
| conditions | SS-RSRP (dBm) | DL SS-SINR (dB) | |
| Excellent | >−75 | >25 | Utilization of the highest possible |
| (cell | | | MCS, transport block size and MIMO |
| centre) | | | rank |
| | | | Peak performance measurements |
| | | | Negligible interference from |
| | | | neighbor cells |
| Good | −75 to −90 | 15 to 20 | |
| | (typical value = −85) | (typical value = 17) | |
| Fair | −90 to −105 | 5 to 10 | |
| | (typical value = −95) | (typical value = 7) | |
| Poor | <−105 | <5 | Minimum performance |
| (cell edge) | (typical value = −110) | (typical value = 3) | measurements |
| | | | Strong interference from neighbor |
| | | | cells |

At step 708, the UE 114 notifies the cell #0 112-0 that RRC reconfiguration is completed.

At step 710, the UE 114 reports the signal of the cell #0 112-0 as being too weak and the signal of the cell #1 112-1 as being good.

At step 712, the cell #0 112-0 will start to execute the handover process and sends RRC reconfiguration message, including the handover request and SRS configuration, to the UE 114.

At step 714, a contention-free random access (CFRA) procedure occurs.

At step 716, the UE 114 notifies the cell #1 112-1 that RRC reconfiguration is completed.

At step 718, the UE 114 starts SRS signal transmission when access is successful.

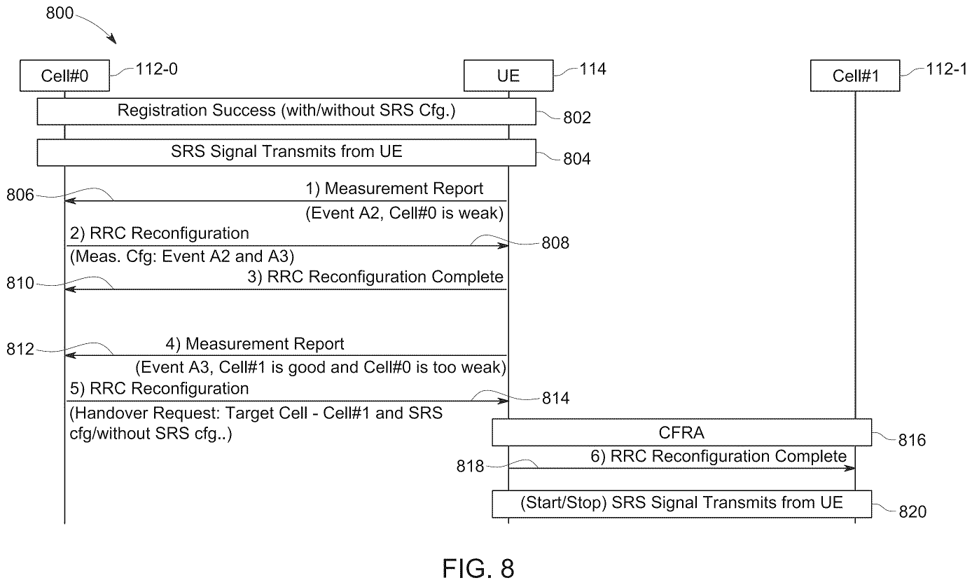

FIG. 8 is a second example scenario 800 for changing SRS resource allocation, according to certain aspects of the present disclosure. In the scenario 800, SRS resource allocation of the UE 114 remains as “enabled” or “disabled.” That is, SRS resource allocation starts from an ON status in a first timestamp and ends in an ON status in a second timestamp, or starts from an OFF status in the first timestamp and ends in an OFF status in the second timestamp. At step 802, the UE 114 successfully registers. Step 802 is similar to or the same as step 702 (FIG. 7) where the UE 114 can register to the network and adopt the measurement configuration for Event A2 defined in 3GPP. When the serving cell (i.e., the cell #0 112-0) is weak, Event A2 is the criteria to be triggered to send the management report.

At step 804, the UE 114 transmits SRS signals. That is, SRS transmission is initially enabled (i.e., ON status).

At step 806, when the UE 114 is separated from cell #0 112-0 by a certain distance, the UE 114 will send the measurement report to inform the serving cell (i.e., cell #0 112-0) of a weak signal. Step 806 is the same as or similar to step 704 (FIG. 7).

At step 808, the cell #0 112-0 will update the measurement configuration (i.e., RCC reconfiguration) with Event A3 defined in 3GPP.

At step 810, the UE 114 notifies the cell #0 112-0 that the RCC Reconfiguration is completed.

At step 812, the cell #0 112-0 will forward the measurement result. For example, the signal of a neighboring cell (e.g., the cell #1 112-1) becomes good and the signal of serving cell (the cell #0 112-0) is too weak. The measurement results are forwarded to the OAM 424 or xApps. Before the handover process is triggered, the updated cell-based SRE table allows updates from not only the OAM 424 but also the nRT-RIC 302 and O-CU of the gNB 110 while the updated UE-based ASRE table allows SRS transmission to be enabled.

At step 814, as the UE 114 is in the coverage of the cell #0 112-0 and the cell #1 112-1, the cell #0 112-0 will start the handover process and send the RRC reconfiguration message (including handover request and SRS configuration) to the UE 114.

At step 816, a CFRA procedure occurs, similar to or the same as step 714.

At step 818, the UE 114 notifies the cell #1 112-1 that RRC reconfiguration is completed.

At step 820, when the UE 114 access is completed successfully, the UE 114 can start SRS transmission for SRS resource allocation.

As provided above, FIG. 8 can be adopted to disabled SRS resource allocation and stopping SRS signal transmission (SRS OFF to OFF scenario) after the handover completes. Compared with ON to ON scenario, the flow difference for the OFF to OFF scenario (OFF remains) is registration Success without SRS configuration at step 802 and stop SRS signal transmission from the UE 114 at step 820.

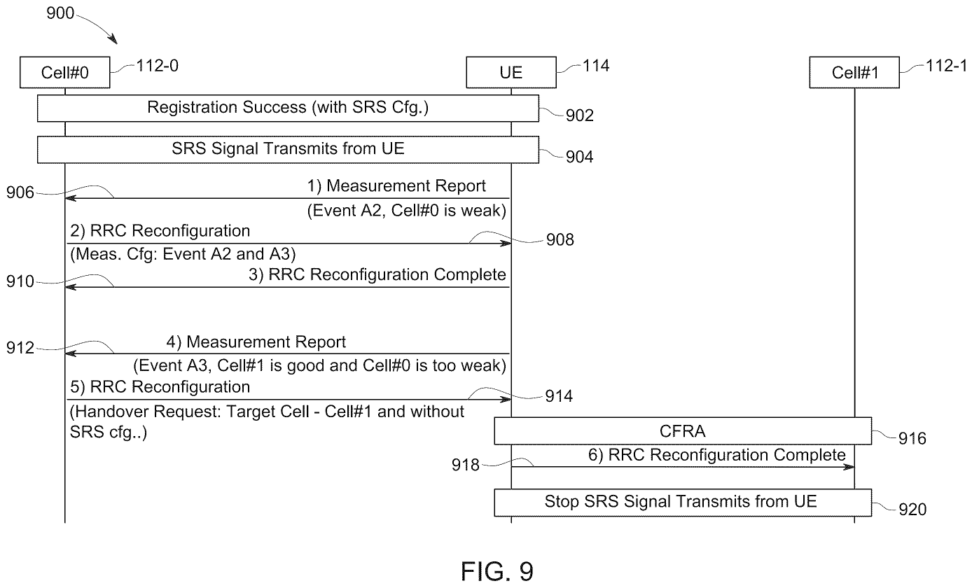

FIG. 9 is a third example scenario 900 for changing SRS resource allocation, according to certain aspects of the present disclosure. In the scenario 700, the SRS resource allocation is changed from an OFF status to an ON status. At step 902, the UE 114 registers to the network and adopts the measurement configuration for Event A2 defined in 3GPP. When the serving cell (i.e., cell #0 112-0) is weak, Event A2 is the criteria to be triggered to send the management report. The management report may include signal intensity in relation to the distance between UE 114 and the serving cell.

At step 904, SRS transmission is initially enabled for the UE 114. Step 904 is similar to or the same as step 804.

At step 906, when the UE 114 leaves the cell #0 112-0 by a certain distance, the UE 114 will send the measurement report to indicate that the serving cell signal is weak. Step 906 is similar to or the same as steps 704 and 806.

At step 908, the cell #0 112-0 updates the measurement configuration for Event A3 and forwards the measurement report to the OAM and/or xApp. Before the handover process is triggered, the updated cell-based SRE table allows updating by not only OAM but also the nRT-RIC and the O-CU while the updated UE-based ASRE table allows SRS transmission to be enabled. Step 908 is similar to or the same as steps 706 and 808.

At step 910, the UE 114 notifies the cell #0 112-0 that the RCC reconfiguration is completed. Step 910 is similar to or the same as steps 708 and 810.

At step 912, the UE 114 reports the signal of the cell #0 112-0 is too weak and the signal of the cell #1 112-1 is good. Step 912 is similar to or the same as steps 710 and 812.

At step 914, the UE 114 is in the coverage area of both the cell #0 112-0 and the cell #1 112-1, thus the cell #0 112-0 will start the handover process and send the RRC reconfiguration message to the UE 114. The RRC reconfiguration message may include handover request without SRS configuration.

At step 916, a CFRA procedure occurs, similar to or the same as steps 714 and 816.

At step 918, the UE 114 notifies the cell #1 112-1 that RRC reconfiguration is completed. Step 918 is similar to or the same as steps 716 and 818.

At step 920, when the UE 114 access is completed successfully, the UE 114 stops SRS transmission (i.e., SRS status is changed to OFF).

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A system comprising:
one or more data processors; and
a non-transitory computer-readable storage medium containing instructions which, when executed on the one or more data processors, cause the one or more data processors to perform operations including:
receiving a measurement report from a user equipment;
updating measurement configuration based on the measurement report;
forwarding a measurement result including status of signal strengths of a serving cell and a neighboring cell to a radio access network (RAN) intelligent controller; and
updating (i) an SRS relation enabler (SRE) table based on an automatic neighbor relationship (ANR), (ii) an automatic SRS relation enabler (ASRE) table, or (iii) both, based on the measurement result, the SRE table storing cell-based information and the ASRE table storing user equipment based information.

2. The system of claim 1, wherein the SRE table is updated to change a status of an SRS resource allocation of the user equipment in a cell.

3. The system of claim 1, wherein the ASRE table is updated to change a status of an SRS resource allocation of the user equipment.

4. The system of claim 1, wherein executing the instructions further causes the one or more data processors to perform operations including:
receiving a notification from the user equipment that a first radio resource control (RRC) reconfiguration is completed;
receiving, from the user equipment, signal strengths of the neighboring cell and the serving cell relative to the user equipment; and
providing a second RRC reconfiguration to the user equipment, the second RRC reconfiguration including a handover request with the neighboring cell being a target cell.

5. The system of claim 4, wherein the second RRC reconfiguration further includes an SRS configuration.

6. The system of claim 1, wherein the SRE table is an extension of a neighbor relation table as defined in the 3GPP.

7. The system of claim 6, wherein the SRE table is updated by a near real time radio access network intelligent controller.

8. The system of claim 6, wherein the SRE table is updated by an open-central unit (O-CU) stack in a base station.

9. The system of claim 1, wherein the ASRE table is updated to track candidate user equipment, the candidate user equipment being one or more user equipment that can execute a handover from the serving cell to the neighboring cell.

10. The system of claim 9, wherein a candidate row of the ASRE table identifies a first cell, a second cell, a first user equipment, and an SRS allocation of the first user equipment being enabled.

11. The system of claim 1, wherein the ASRE table is updated to track dropped user equipment, the dropped user equipment being one or more user equipment where an SRS allocation is disabled.

12. The system of claim 11, wherein a dropped row of the ASRE table identifies at least one cell and one user equipment.

13. A method performed by a computing system, the method comprising:
receiving a measurement report from a user equipment;
updating measurement configuration based on the measurement report;
forwarding a measurement result including status of signal strengths of a serving cell and a neighboring cell to a radio access network (RAN) intelligent controller;
updating an SRS relation enabler (SRE) table based on automatic neighbor relationship (ANR), an automatic SRS relation enabler (ASRE) table, or both, based on the measurement result, the SRE table storing cell-based information and the ASRE table storing user equipment based information.

14. The method of claim 13, wherein the SRE table is updated to change a status of an SRS resource allocation of the user equipment in a cell.

15. The method of claim 13, wherein the ASRE table is updated to change a status of an SRS resource allocation of the user equipment.

16. The method of claim 13, further comprising:
receiving a notification from the user equipment that a first radio resource control (RRC) reconfiguration is completed;
receiving, from the user equipment, signal strengths of the neighboring cell and the serving cell relative to the user equipment; and
providing a second RRC reconfiguration to the user equipment, the second RRC reconfiguration including a handover request with the neighboring cell being a target cell.

17. The method of claim 16, wherein the second RRC reconfiguration further includes an SRS configuration.

18. The method of claim 13, wherein the SRE table is an extension of a neighbor relation table as defined in the 3GPP.

19. The method of claim 13, wherein the ASRE table is updated to track candidate user equipment, the candidate user equipment being one or more user equipment that can execute a handover from the serving cell to the neighboring cell.

20. The method of claim 13, wherein the ASRE table is updated to track dropped user equipment, the dropped user equipment being one or more user equipment where an SRS allocation is disabled.
